(19) United States
(12) Patent Application Publication
(10) Pub. No.: US 2009/0132616 A1
(43) Pub. Date: May 21, 2009

(54) ARCHIVAL BACKUP INTEGRATION

(76) Inventors: Richard Winter, Longmont, CO (US); Brian Dodd, Longmont, CO (US); Michael Moore, Lafayette, CO (US)

Correspondence Address: MARSH, FISCHMANN & BREYFOGLE LLP, 8055 East Tufts Avenue, Suite 450, Denver, CO, 80237, US

(21) Appl. No.: 12/244,394

(22) Filed: Oct. 2, 2008

Related U.S. Application Data
(60) Provisional application No. 60/977,025, filed on Oct. 2, 2007.

(51) Int. Cl. G06F 17/30

(52) U.S. Cl. 707/204; 707/E17.005

(57) ABSTRACT

The inventive systems/techniques described herein provide solutions to managing information that may be integrated with many existing back-up applications. The techniques use existing resources, and provide transparent access to additional data processing functionalities. In one arrangement, a data de-duplication technique is provided. The technique includes monitoring a computer system to identify an intended transfer of a data set to an electronic storage medium. Once an intended transfer is identified, the data set is processed (e.g., prior to transfer). Such processing includes identifying a portion of the data set that corresponds to previously stored data and replace that portion of the data set with a link to the previously stored data. Such replacement of data portions within the first data set with links to previously stored data defines a modified data set. The modified data set may be transferred to the electronic storage medium associated with, for example, a back-up application/system.

### CROSS REFERENCE

This application claims the benefit of the filing date, under 35 USC § 119, of U.S. Provisional Application No. 60/997,025 entitled “Archival Backup Integration” having a filing date of Oct. 2, 2007, the entire contents of which are incorporated herein by reference.

### FIELD

The present application is directed to storing electronic data. More specifically, the present application is directed to utilities for use in efficient storage and transfer of electronic data.

### BACKGROUND

Many organizations back up their digital data on a fixed basis. For instance, many organizations perform a weekly backup where all digital data is duplicated. In addition, many of these organizations perform a daily incremental backup such that changes to the digital data from day-to-day may be stored. Often, such backup data is transferred to an off-site data repository. However, traditional backup systems have several drawbacks and inefficiencies. For instance, during weekly backups, where all digital data is duplicated, fixed files, which have not been altered, are duplicated. As may be appreciated, this results in an unnecessary redundancy of digital information as well as increased processing and/or bandwidth requirements.

Another problem, for both weekly as well as incremental backups is that minor changes to dynamic files may result in inefficient duplication of digital data. For instance, a one-character edit of a 10 MB file requires that the entire contents of the file to be backed up and cataloged. The situation is far worse for larger files such as Outlook Personal Folders (.pst files), whereby the very act of opening these files causes them to be modified which then requires another backup.

The typical result of these drawbacks and inefficiencies is that most common back-up systems generate immense amounts of data. Accordingly, there have been varying attempts to identify the dynamic changes that have occurred between a previous backup of digital data and current set of back-up digital data. The goal is to only create a backup of data that has changed (i.e., dynamic data) in relation to a previous set of digital data. That is, there have been attempts to de-duplicate redundant data stored in back-up storage. Typically, such de-duplication attempts have occurred after transferring a full set of current digital data to a data repository where the back up of a previous set of the digital data is stored.

### SUMMARY

The inventive systems/techniques described herein provide solutions to managing information as well as providing solutions that may be integrated with many existing back-up applications. The techniques use existing resources, and provide transparent access to additional data processing functionalities. That is, the present techniques may integrate with an existing back-up application at the point of interface between the back-up application and an existing data set. In this regard, the integration of the inventive system/techniques with an existing back-up application may be implemented without requiring specialized interfaces with an existing back-up application and/or access to proprietary coding of the back-up application.

In one aspect, a system and method (i.e., utility) is provided that allows for performing a processing function on a data set upon identifying the initiation of a transfer of that data set to or from a data storage device. The utility includes monitoring input and/or output requests of a computer/server system. Upon identifying a request for initiating transfer or retrieval of a stored data set, the utility may perform one or more functions on that data set prior to the data set being stored to storage and/or the data set being provided to the computer system. Stated otherwise, the data set may be intercepted prior to receipt by a storage device or prior to receipt by a computer system. In any case, a data processing function may be performed on the data set while the data set moves between the computer system and the data storage device. Once such a data processing function is performed, a modified data set may be provided to the computer system or data storage device, as the case may be.

In different arrangements, different data processing functions may be performed. In this regard, the utility may be operative to identify what type of data transfer event is being performed based on the I/O request. Accordingly, different functions may be selected based on different identified data transfer events. For instance, the utility may identify transfer events where data is to be stored to local storage, transfer events where data is to be stored to back-up and/or off-site storage, transfer events occurring in secured networks, transfer events occurring in unsecured networks, etc. Illustrative data processing functions that may be performed include, without limitation, compression, decompression, encryption, de-encryption, data de-duplication and data inflation.

Such data processing functions may, in one arrangement, be performed before transferring the data set to the receiving component. It will be appreciated this may provide various benefits. For instance, data compression may be performed prior to transferring the data set over a network thereby reducing bandwidth requirements. It will be appreciated that the present utility as well as the utilities discussed herein may be utilized in applications where a computer system/server and a backup application/device are interconnected by a network. Such networks may include any network that is operative to transfer electronic data. Non-limiting examples of such networks include local area networks, wide-area networks, telecommunication networks, and/or IP networks. In addition, the present utility may be utilized in direct connection applications where, for example, a backup device is directly connected to a computer/server system.

According to another aspect, a data de-duplication system and method (i.e., utility) is provided that may be integrated with existing back-up applications/systems. The utility includes monitoring a computer system to identify transfer of a data set to an electronic storage medium. The utility the further includes processing the data set prior to transfer to the electronic storage medium. Such processing includes identifying a portion of the data set that corresponds to previously stored data. Such previously stored data may be stored on any electronic storage device including the storage device associated with the backup application/system. In other arrangements, the electronic storage device that stores previously stored data may be a separate data storage device. In any arrangement, upon identifying a portion of the data that has been previously stored, the utility is operative to replace that portion of data with a link to the previously stored data. Such replacement of data portions within the first data set with links to previously stored data defines a modified data set. The modified data set may be transferred to the electronic storage medium associated with the back-up application/system.

The inventive utility provides a long-term solution to managing information as well as providing a solution that may be integrated with many existing back-up applications. The data de-duplication techniques of the utility use existing disk resources, and provide transparent access to collections of archived information. These techniques allow for large increases (e.g., 20:1 or more) in effective capacity of back-up systems with no changes to existing short-term data protection procedures. More importantly, the presented techniques may integrate with an existing back-up application at the point of interface between the backup application and an existing data set.

The utility allows data de-duplication to be performed at an interface between a data set and a backup application. In this regard, only new or otherwise altered data may be received for storage by a backup application. Therefore the volume of data received by the back-up application/system may be significantly reduced. Further, no changes need to be made to an organizations current back-up application/system and functionality (e.g., reporting, data sorting, etc.). That is, an existing backup application/system may continue to be operative.

To better optimize the long term storage of content, the utility reduces redundant information for a given data set prior that data set being transmitted to a backup application. This reduces bandwidth requirements and hence reduces the time required to perform a backup operation. In one arrangement, when a file is selected for backup, an archive is checked to see if the archive contains a copy of the data. If the data is within the archive, the backup application may receive an image of the file that does not contain any data. For files not within the archive, the backup application may receive a full backup image.

In one arrangement, the archive system utilizes an index of previously stored data to identify redundant or common data in the data set. This index of previously stored data may be stored with the previously stored data, or, the index may be stored separately from the previously stored data. For instance, the index may be stored at the origination location (e.g., computer/server) of a given data set. In one arrangement, the index is formed by hashing one or more attributes of the stored data. Corresponding attributes of the data set may likewise be hashed prior to transfer. By comparing these hashes, redundant data may be identified. In one arrangement, the index is generated in an adaptive content factoring process in which unique data is keyed and stored once. For a given version of a data set, new information is stored along with metadata used to reconstruct the version from each individual segment saved at different points in time.

The integration of the utility with an existing backup application (i.e., backup integration) may be achieved by using a file system filter or driver. This filter intercepts requests for all file 10. Such a filter may be implemented on any operating system with, for example, any read/write requests. On the Windows operating system most back-up applications use standard interfaces and protocols to back up files. This includes the use of a special flag when opening the file (open for backup intent). There are also interfaces to backup (BackupRead) and restore (BackupWrite) files. The BackupRead interface performs all the file operations necessary to obtain a single stream of data that contains all the data that comprises the file. On the NTFS file system this includes a primary data stream, attributes, security information, potentially named data steams and, in some cases, other information.

The filter detects when files are opened for backup intent and checks to see if there is currently a copy of a portion of the file data in the archive. If there is, the portion of the file data may be removed and replaced with a link to the previously stored portion. In one arrangement, this is performed during back-up by the filter, which fetches file attributes for the file and adds attributes (e.g., sparse and reparse points) to the actual attribute values. The reparse point contains data (e.g., a link) that is used to locate the original data stream in a de-duplicated data storage.

These attributes cause a backup application interface to do two things. It will first read the reparse point data. This request is intercepted and the filter driver creates the reparse data (only files that do not already contain reparse points are eligible for this treatment) that is needed and returns this to the backup application interface. Because the file is sparse the backup interface will query to see what parts of the primary data stream have disk space allocated. The filter intercepts this request and tells the backup application interface that there are no allocated regions for this file. Because of this, the backup application interface does not attempt to read the primary data stream and just continues receiving the rest of the file data.

When a data set or file is restored, the backup application interface takes the stream of data and unwinds it to recreate the file. When the interface attempts to write the reparse point the filter sees this and attempts to fetch the original data from the archive (using the link or reparse data to determine what data to request) and writes the original data back to the file being restored. If this operation is successful the filter returns a success code to the backup application interface without actually having written the reparse point (restoring the file instead). If the archive is not available for some reason (or this feature is disabled) the reparse data is written to the file and no further action is taken on the file during the rest of the restore operation.

The backup application interface may then try to set the sparse file attribute. This operation is intercepted and if the file data was restored without error the filter returns success without setting the sparse attribute. The backup application interface will also try and set the logical file size by seeking to offset zero and writing zero bytes and seeking to the end of the file and writing zero bytes. If the file were really sparse this would set the logical size. Since it is not really sparse, requests are intercepted and returned as successes without actually doing anything. The end result of all this is that the file is restored exactly as it was when it was backed up.

If this feature is turned off (or an error prevents access to the original file data) and the file is restored with the reparse point and sparse attribute then the filter driver will see this later when the file is opened for use by any other application. The initial request to open the file is just passed directly through to the file system. The reparse point causes the file system to return a special error that is detected by the filter driver on the way back to the application. When this error code is seen the filter driver looks at the reparse data (also returned by the file system) and if it is the tag value is assigned to the vendor implementing the filter driver then this file is flagged with context (as was done during backup). In this regard, it will be appreciated that the tag value is a number assigned to software vendors that use reparse points. Stated otherwise, the filter driver looks for reparse tag(s) it owns and ignores those assigned to other vendors. If the file is read or written the request is blocked by the filter driver until the file data is fetched from the archive and restored to the file system.

### BRIEF DESCRIPTION OF THE DRAWINGS

FIG. 1 illustrates one embodiment of a back-up system utilized with a plurality of computers/servers.

FIG. 2 illustrates the interconnection of a single computer/server to a back-up application where a data de-duplication system is incorporated.

FIG. 3 illustrates a process for intercepting input/output requests from a back-up application in a file system.

FIG. 4 illustrates identification of files opened for back-up content.

FIG. 5 illustrates the addition of a link to previously stored data to a data file.

FIG. 6 illustrates restoring an original data file from a file including links to previously stored data.

FIG. 7 illustrates a process for generating an index for a data set.

### DETAILED DESCRIPTION

Reference will now be made to the accompanying drawings, which assist in illustrating the various pertinent features of the present invention. Although the present invention will now be described primarily in conjunction with de-duplication of data prior to storage of the data to a back-up application system, it should be expressly understood that the present invention may be applicable to other applications. For instance, aspects of the invention may allow performing other data management functions (e.g., encryption compression, etc.) upon identifying initiation of a storage function/event (e.g., read, write, etc.) for a data set. In this regard, the following description is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. In one embodiment, the present invention utilizes the content factoring and distributed index system as set forth in co-owned U.S. patent application Ser. No. 11/733,086, entitled “Data Compression and Storage Techniques,” the contents of which are incorporated herein by reference.

The systems and methods described herein allow for performing various data management techniques on a data set upon the identification of one or more actions being taken with regard to the data set. Stated otherwise, the systems and methods described herein allow for identifying a predetermined event in relation to a data set and, prior to such event occurring, performing one or more data management techniques/processing functions. Such data management techniques may include, without limitation, compression, encryption and/or data de-duplication. Such predetermined events may include writing or reading a data set to or from a data storage device. As utilized herein, the term “data set” is meant to encompass any electronic data that may be stored to an electronic storage device without limitation. Generally, the systems and methods utilize a filter or other module with a computer/server system that allows for identifying one or more data processing requests and implementing a secondary data processing function in conjunction with the data processing request.

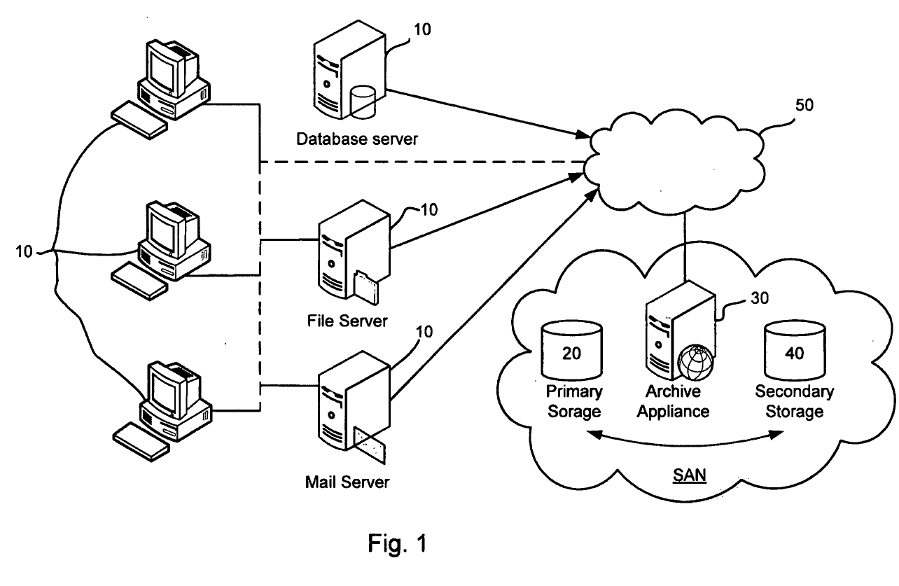

The data de-duplication techniques described herein use locally cacheable indexes of previously stored data content to de-duplicate a data set(s) prior to backing-up or otherwise storing such a data set(s). Such pre-storage de-duplication may reduce bandwidth requirements for data transfer and/or allow for greatly increasing the capacity of a data storage device or a back-up application/system. As illustrated in FIG. 1, multiple servers/computers 10 may in one embodiment share a common back-up storage facility. In other embodiments, a single server/computer may interface with a back-up storage system 30 and/or storage device 20. The back-up system 30 may be co-located with the computer/servers 10 via, for example, a local area network 50 or other data communications links. In the illustrated embodiment, the back-up system 30 includes an archive appliance which may be interconnected to one or more storage devices 20, 40. The storage devices 20, 40 may be connected via a SAN (storage area network) and/or utilizing direct connections. In other embodiments, the back-up applications may be co-located with the server/computers. In remote location arrangements, the computers/servers 10 may communicate with the back-up system 30 via a communications network, which may include, without limitation, wide area network, telephonic networks as well as packet switched networks (e.g., Internet, TCP/IP etc).

Content of the data sets stored on one or more such computers/servers 10 may include common content. That is, content of one more portions of different data sets or individual data sets may include common data. For instance, if two computers store a common power point file, or, if a single computer stores a power point file under different two file names, at least a portion of the content of these files would be duplicative/common. By identifying such common content, the content may be shared by different data sets or different files of a single data set. That is, rather than storing the common content multiple times, the data may be shared (e.g., de-duplicated) to reduce storage requirements. As is discussed herein, indexes may be generated that allow for identifying if a portion or all of the content of a data set has previously been stored, for example, at a back-up system 30 and/or on the individual computers/servers 10.

To back-up the data sets of individual servers/computers, the presented techniques may use distributed indexes. For instance, specific sets of identifiers such as content hashes may be provided to specific server/computers to identify existing data for that server/computer prior to transfer of data from the specific computer/server to a back-up application. Generally, the techniques monitor a computer system for storage operations (e.g., back-up operations) and, prior to transmitting a data set during the storage operations, remove redundant data from the data set. In any arrangement, the techniques discussed herein allow for identifying duplicative data before backing-up or otherwise storing a data set.

### System Environment

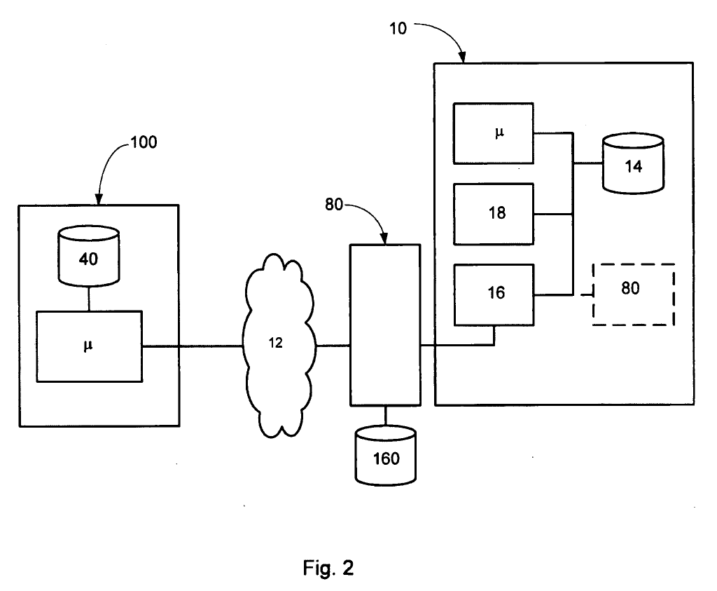

FIG. 2 is a schematic block diagram of a computing environment in which the present techniques may be implemented. As shown, a computer/server 10 (hereafter computer system) interfaces with a back-up storage application/system 100 that may be used with various embodiments of the present invention. Generally, the computer system 10 comprises a processor 12, a memory 14, a network adapter 16, random access memory (RAM) 18 which are operatively interconnected (e.g., by a system bus). The memory 12 comprises storage locations that are addressable by the processor(s) for storing software program code and or data sets. The processor may, in turn, comprise processing elements and/or logic circuitry configured to execute the software code and manipulate the data structures. It will be apparent to those skilled in the art that other processing and memory means, including various computer readable media, may be used for storing and executing program instructions pertaining to any computerized application.

The network adapter 16 includes the mechanical, electrical and signaling circuitry needed to connect the computer system 10 to a computer network 50, which may comprise a point-to-point connection or a shared medium, such as a local area network. In the illustrated embodiment, the computer system may communicate with a stand-alone back-up storage system over a local area network 50.

The back-up storage application/system 100 is, in the present embodiment, a computer systems/server that provides storage service relating to the organization of information on electronic storage media/storage devices, such as disks, a disk array and/or tape(s). In other embodiments, portions of the back-up storage system may be integrated into the same platform with the computer system 10 (e.g., as software, firmware and/or hardware). The back-up storage system may be implemented in a specialized or a general-purpose computer configured to execute various storage applications. The back-up system may utilize any electronic storage system for data storage operations. For example, the backup storage system may function as backup server to store backups of data sets contained on one or more computers/server for archival purposes. The data sets received from the computer/server information may be stored on any type of writable electronic storage device or media such as video tape, optical, DVD, magnetic tape, bubble memory, electronic random access memory, micro-electro mechanical and any other similar media adapted to store information.

In other arrangements, it will be appreciated that the back-up storage system may be a removable storage device that is adapted for interconnection to the computer system 10. For instance, such a back-up system may be, without limitation, a tape drive, disk (san, USB, direct attached), worm media (DVD or writable CD), virtual tape libraries etc.

Disposed between the computer system and the back-up system is a de-duplication system 80, in accordance with various aspects of the invention. The de-duplication system 80 is operative to intercept 10 requests from the computer and identify storage operations or events. Upon identifying such events, the system 80 may access indexes (e.g., from storage) for use in identifying redundant data in a data set for which a storage event is requested. Though illustrated as a standalone unit, it will be appreciated that the de-duplication system may be incorporated into a common platform with the computer system 10. Furthermore, it will be appreciated that the de-duplication system 80 may be incorporated into a common platform with the back-up system.

It will be understood to those skilled in the art that the data storage and de-duplication systems described herein may apply to any type of special-purpose (e.g., file server, filer or multi-protocol storage appliance) or general-purpose computers.

### Data De-Duplication

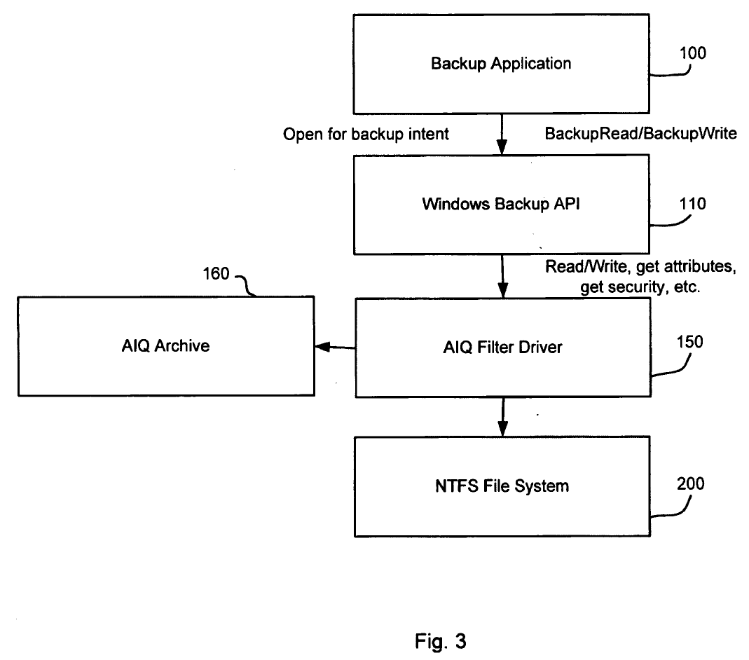

FIG. 3 illustrates the integration of a de-duplication system, which allows for de-duplication of redundant or common data, at an interface between an existing backup application 100 and a file system 200. In the illustrated embodiment, the de-duplication system includes a filter 150 for monitoring storage events and an electronic storage device 160 for archival storage of data sets of the file system 200. In such an arrangement, subsequent backups of file system data sets may be greatly reduced as the data within the file system 200 is compared with the data stored by the de-duplication system to determine if the data already exists. If so, the data is not duplicated (e.g., backed up) by the backup application 100. While such an arrangement utilizes first and second storage systems (e.g., archive system 160 and backup application 100), it will be appreciated that this implementation has several advantages. First, the de-duplication system determines which data is duplicative data that does not need to be transmitted to the backup application 100. Further, the backup application 100 may be a familiar platform for an organization and/or may be specifically configured for that organization. That is, specialized functionality of the backup application 100 is still available irrespective of the integration with the de-duplication system. In this regard, the data de-duplication system is transparent to the users of the backup system.

In the present embodiment, the de-duplication system is integrated between the interface of a backup application 100 and a Windows-based (e.g., NTFS) operating system utilizing BackupRead and BackupWrite APIs. This is presented by way of example and not by way of limitation. In this regard, it will be appreciated that certain aspects of the present invention may be implemented in other operating systems including, without limitation, UNIX and Linux based operating systems and/or with other read/write operations.

As illustrated, a data backup system 100 utilizes a Windows backup application program interface (API) 110 to access the file system 200 for backup purposes. On the Windows operating system most backup applications use standard interfaces and protocols (BackupRead and BackWrite) to back up files. This includes the use of a special flag when opening the file (open for backup intent). The BackupRead protocol performs all the file operations necessary to obtain a single stream of data that contains all the data that comprises the file. On the NTFS file system this includes the primary data stream, the attributes, security information, possibly some named data streams and possibly other information. In the vast majority of the cases the primary data stream is by far the largest amount of data.

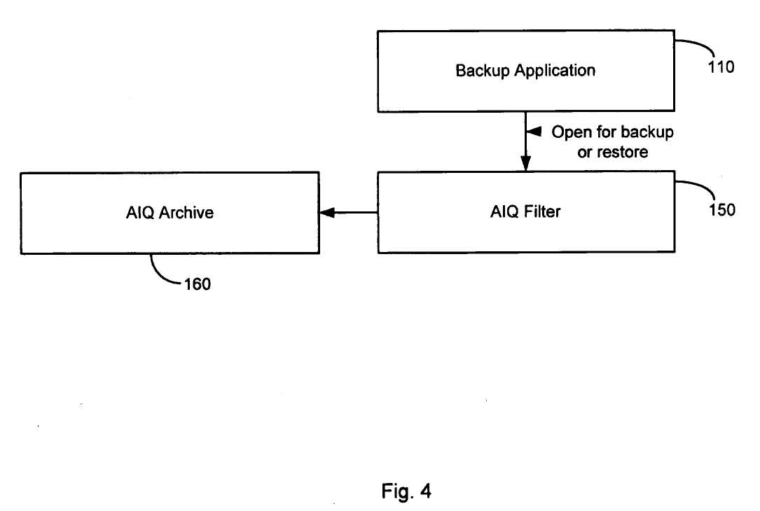

Disposed between the API 110 and the file system 200 is a filter driver 150 of the de-duplication system. This filter driver 150 intercepts all requests for file input and output. Stated otherwise, the filter driver monitors the API 110 for backup requests (e.g., BackupRead requests). See FIG. 4. In this regard, the filter driver 150 detects when files are opened for backup intent. Accordingly, upon determining that a file has been open for backup intent, the filter driver 150 may access an index in the archive 160. A determination may be made as to whether all or a portion of the file has been previously stored (e.g., archived). If the file is within the archives the handle request is marked “with context.” When other file operations are seen, (such as, for example, query file information, get reparse point, query allocated regions, write file, etc.) this context can be quickly retrieve determine if a further action is required. That is, if the file exists, the file may be flagged for future reference. This involves adding a pointer and/or context information to the file object. The filter driver sees all requests to the file and during certain requests it looks for the presence of this context information. If the file object contains the context information the request is one that the filter will take action on.

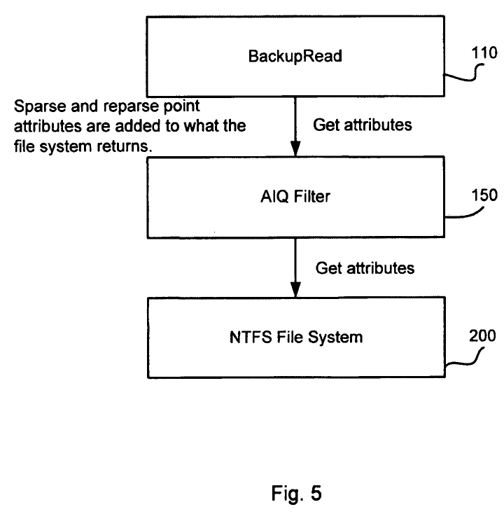

During backup, the Backup Read API 110 will request file attributes. See FIG. 5. If the file is one of interest (it has the context) then the filter 150 fetches the file attributes for the file from the file system 200. In addition, the filter 150 adds two attributes (sparse and reparse point) to the actual attribute values of the file. The reparse point includes a tag value and a data portion. The data portion is defined by the software vendor and in this case does contain index information. There is also a file attribute (like the read-only attribute) that indicates the presence of a reparse point. The backup read 110 firsts looks to see if the attribute is set and if it is then it reads the reparse data. This request is intercepted and the filter 150 creates the reparse data (only files that do not already contain reparse points are eligible for this treatment) that is needed and returns this to the BackupRead API. Because the BackupRead was told that the file is sparse the BackupRead API will query to see what parts of the primary data stream have disk space allocated. The filter driver intercepts this request and tells BackupRead that there are no allocated regions for this file. Because of this BackupRead does not attempt to read the primary data stream and just continues receiving the rest of the file data. This causes the BackupRead data stream to be much smaller than it otherwise would be—the larger the file the greater the difference. In this regard, the system does not back-up or transmit unallocated blocks of the sparse files.

Index information for the location and composition of a file in the archive system 160 may be provided to the backup application 100 which may store this information in place of a backup of the existing file of the file system 200. That is, a portion of the data of a file may be removed and replaced with a link or address to a previously stored copy of that portion of data. Furthermore, this information may be utilized by the backup application 100 when recreating data from the file system, as will be discussed herein. In instances where a file requested from the file system 200 does not exist in the archive (i.e., a new file is being backed up), the de-duplication system 80 may parse and index the file as set forth in U.S. patent application Ser. No. 11/733,086, as incorporated above. The system 80 may then provide the appropriate index information to the backup application. Further, if desired a full copy of the new file may be made available to the backup application 100 for storage.

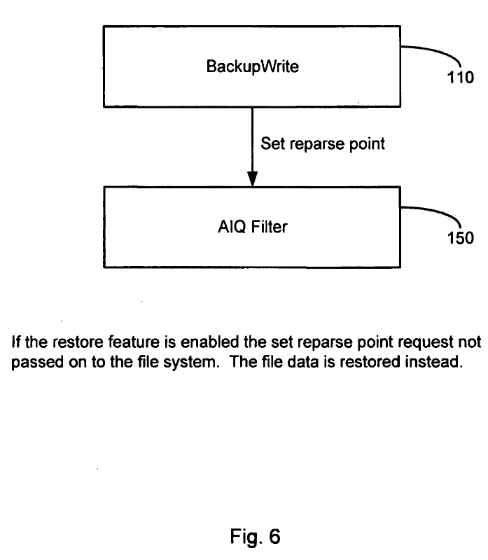

When a file is restored from the backup application 100, the BackupWrite API takes the stream of data from the application 100 and unwinds it to recreate the file. See FIG. 6. In the present embodiment, the backup file may include a reparse point that contains a pointer to file data stored by the archive 160. When the BackupWrite API 110 sees the reparse point, it tries to write it back to the file system. The filter driver 150 sees this and fetches the actual data from the archive 160 (using the reparse point data to determine what data to ask for). If this operation is successful the filter 150 returns a success code to the BackupWrite API without actually having written the reparse point (restoring the file instead). If the archive is not available for some reason (or this feature is disabled) the reparse data is written to the file and no further action is taken on the file during the rest of the restore operation.

The BackupWrite API now sets the sparse file attribute(s) for a file having any such attributes. This operation is intercepted by the filter 150 and if the file data was restored without error the filter 150 returns a success code without setting the sparse attribute. The BackupWrite API 110 may also try and set the logical file size by seeking to offset zero and writing zero bytes and seeking to the end of the file and writing zero bytes. If the file were really sparse this would set the logical size. Since it is not really sparse this request is intercepted and a success code is returned without actually performing any function. The end result of is that the file is restored exactly as it was when it was backed up.

To provide de-duplication techniques discussed above, an initial data set must be originally indexed. Such an index forms a map of the location of the various components of a data set and allows for the identification of common data as well as the reconstruction of a data set at a later time. In one arrangement, the first time a set of data is originally backed up to generate an initial or baseline version of that data, the data may be hashed using one or more known hashing algorithms. The present application utilizes multiple hashes for different portions of the data sets. Further, the present application may use two or more hashes for a common component. In any case, such hash codes may form a portion of the index or catalog for the system.

A data set may be broken into three different data streams, which may each be hashed. These data streams may include baseline references that include Drive/Folder/File Name and/or server identifications for different files, folders and/or data sets. The baseline references relates to the identification of larger sets/blocks of data. A second hash is performed on the metadata (e.g., version references) for each of the baseline references. In the present embodiment, the first hash relating to the baseline reference (e.g., storage location) may be a sub-set of the meta-data utilized to form the second hash. In this regard, it will be appreciated that metadata associated with each file of a data set may include a number of different properties. For instance, there are between 12 and 15 properties for each such version reference. These properties include name, path, server & volume, last modified time, file reference id, file size, file attributes, object id, security id, and last archive time. Finally, for each baseline reference, there is raw data or Blobs (Binary large objects) of data. Generally, such Blobs of data may include file content and/or security information. By separating the data set into these three components and hashing each of these components, multiple checks may be performed on each data set to identify changes for subsequent versions.
1st Hash
   Baseline Reference—Bref
      Primary Fields
      Path\Folder\Filename
      Volume Context
Qualifier
   Last Archive Time
2nd Hash

Version Reference—Vref (12-15 Properties)
Primary Fields (change indicators)
   Path\Folder\Filename
   Reference Context (one or three fields)
   File Last Modification Time (two fields)
   File Reference ID
   File Size (two fields)
Secondary Fields (change indicators)
   File Attributes
   File ObjectID
   File SecurityID
Qualifier
   Last Archive Time
   3rd Hash (majority of the data)
   Blobs (individual data streams)
      Primary Data Stream
      Security Data Stream
      Remaining Data Streams (except Object ID Stream)

In another arrangement, a compound hash is made of two or more hash codes. That is, the VRef, BRef, and Blob identifiers may be made up of two hash codes. For instance, a high-frequency (strong) hash algorithm may be utilized, alongside a low-frequency (weaker) hash algorithm. The weak hash code indicates how good the strong hash is and is a first order indicator for a probable hash code collision (i.e., matching hash). Alternately, an even stronger (more bytes) hash code could be utilized, however, the processing time required to generate vet stronger hash codes may become problematic. A compound hash code may be represented as:

$$ba = \text{"} 01154943 b 7 a 6 ee 0 e 1 b 3 db 1 ddf 0996 e 924 b 60321 d \text{"} \qquad$$

$$\begin{matrix} \vert strong hash component & \vert weak \vert \\ \vert high \text{-} frequency & \vert low \vert\end{matrix}$$

In this regard, two hash codes, which require lees combined processing resources than a single larger hash code are stacked. The resulting code allows for providing additional information regarding a portion/file of a data set.

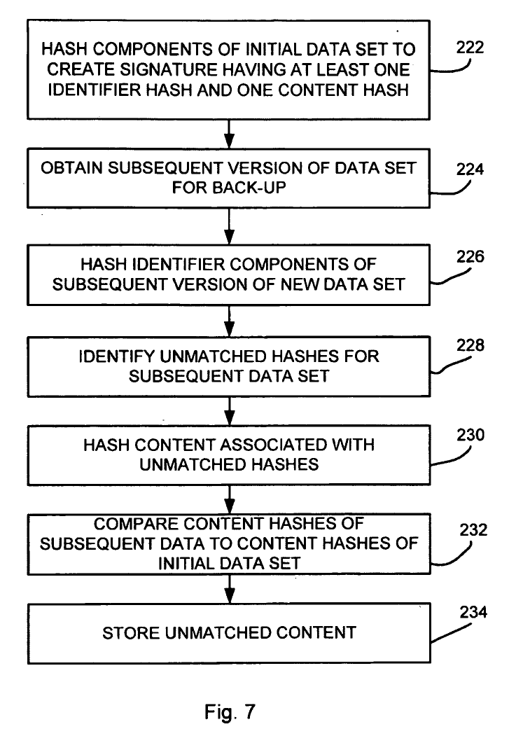

Generally, as illustrated by FIG. 7, an initial set of data is hashed into different properties in order to create a signature 222 associated with that data set. This signature may include a number of different hash codes for individual portions (e.g. files) of the data set. Further each portion of the data set may include multiple hashes (e.g., hashes 1-3), which may be indexed to one another. For instance, the hashes for each portion of the data set may include identifier hashes associated with the metadata (e.g., baseline references and/or version references) as well as a content hash associated with the content of that portion of the data set. When a subsequent data set is obtained 224 such that a back-up may be performed, the subsequent data set may be hashed to generate hash codes for comparison with the signature hash codes.

However, as opposed to hashing all the data, the meta data and the baseline references, or identifier components of the subsequent data set, which generally comprise a small volume of data in comparison to the data Blobs, may initially be hashed 226 in order identify files 228 (e.g., unmatched hashes) that have changed or been added since the initial baseline storage. In this regard, content of the unmatched hashes (e.g., Blobs of files) that are identified as having been changed may then be hashed 230 and compared 232 to stored versions of the baseline data set. As will be appreciated, in some instances a name of a file may change between first and second back ups. However, it is not uncommon for no changes to be made to the text of the file. In such an instance, hashes between the version references may indicate a change in the modification time between the first and second back ups. Accordingly, it may be desirable to identify content hashes associated with the initial data set and compare them with the content hashes of the subsequent data set. As will be appreciated, if no changes occurred to the text of the document between back ups, the content hashes and their associated data (e.g., Blobs) may be identical. In this regard, there is no need to save data associated with the renamed file (e.g., duplicative data). Accordingly, a new file name may share a reference to the baseline Blob of the original file. Similarly, a file with identical content may reside on different volumes of the same server or on different servers. For example, many systems within a workgroup contain the same copy of application files for Microsoft Word®, or the files that make up the Microsoft Windows® operating systems. Accordingly, the file contents of each of these files may be identical. In this regard, there is no need to resave data associated with the identical file found on another server. Accordingly, the file will share a reference to the baseline Blob of the original file from another volume or server. In instances where there is unmatched content in the subsequent version of the data set from the baseline version of the data set, a subsequent Blob may be stored 234 and/or compressed and stored 234.

Importantly, the process 220 of FIG. 7 may be distributed. In this regard, the hash codes associated with the stored data may be provided to the origination location of the data. That is, the initial data set may be stored at a separate storage location. By providing the hash codes to data origination location, the determination of what is new content may be made at the origination location of the data. Accordingly, only new data may need to be transferred to a storage location. As will be appreciated, this reduces the bandwidth requirements for transferring backup data to an off-site storage location. As set forth in relation to FIGS. 3-6, the de-duplication system may utilize the hash codes to identify previously stored data. In this regard, reparse points may include one or more hash codes identifying the location of previously stored data that is included within a dataset or file.

In one exemplary application, a de-duplication system in accordance with the present teachings was integrated into an existing file system that utilized an existing backup application. The file system included a random set of 5106 files using 2.06 GB of disk space. The average file size was about 400 K. A first backup was performed utilizing only the existing backup application. In a second backup, all files were archived and indexed by the de-duplication system prior to back up. Without the integration of the de-duplication system to identify duplicate data, the first backup results in a file of 2.2 GB and took over 16 minutes to complete. With the integration of the system for identifying duplicate data, the second backup resulted in a file of 21 MB and took one minute and 37 seconds.

The results of the comparison between backup utilize an existing application and backup utilizing the archive system and filter indicate that due to the reduced time, bandwidth and storage requirements, an organization may opt to perform a full backup each time data is backed up as opposed to partial backups. Further, when files within the backup system are expanded back to their original form this may be performed through the original backup system that integrates with the de-duplication system transparently.

1. A method for providing data deduplication in a data storage application, comprising:
monitoring a computer operating system to identify a transfer of a data set to an electronic storage medium;
processing said data set prior to transfer to said electronic storage medium, wherein processing comprises:
identifying a portion of said data set that corresponds to a previously stored data portion that is stored on at least one electronic storage device;
replacing said portion of said data set with a link to said previously stored data portion to define a modified data set; and
transferring said modified data set to said electronic storage medium.

2. The method of claim 1, wherein monitoring comprises:
identifying an output of said computer operating system indicating a data back-up event.

3. The method of claim 2, wherein identifying comprises identifying the opening of said data set for said data back-up event.

4. The method of claim 1, wherein processing said data set further comprises:
processing at least one attribute associated with said data set and comparing said at least attribute as processed to an index of previously stored attributes.

5. The method of claim 4, wherein processing said at least one attribute comprises:
hashing said at least one attribute to generate at least one hash code, wherein comparing comprises comparing said at least one hash code to an index of previously stored hash codes.

6. The method of claim 1, wherein processing said at least one attribute comprises processing a primary data stream of said data set.

7. The method of claim 4, wherein said step of comparing comprises:
accessing said index stored on a local electronic storage medium, wherein said index is stored separately from said previously stored data portion.

8. The method of claim 1, wherein replacing said portion of said data set further comprises:
removing said portion of data from said data set and inserting a reparse point into said data set.

9. The method of claim 8, further comprising:
inserting a sparse attribute into said modified data set

10. The method of claim 1, wherein monitoring further comprising:
filtering an output of said computer operating system to identify said transfer.

11. The method of claim 10, further comprising:
intercepting said data set prior to transfer to said electronic storage medium.

12. The method of claim 1, wherein transferring said modified data set to said electronic storage medium comprises transferring said modified data set to the same electronic storage device containing said previously stored data portion.

13. The method of claim 1, wherein transferring said modified data set comprises:
transferring said modified data set over a network interface.

14-16. (canceled)

17. The method of claim 1, wherein transferring said modified data set comprises transferring said modified data set to a platform containing said previously stored data.

18. (canceled)

19. A system for providing data deduplication in backup data storage, comprising:
a computer system having a first electronic storage device for storing a first data set;
a filter module for identifying an impending transfer of said first data set to a second electronic storage device, said filter module further operative to:
process said first data set prior to transfer to said second electronic storage device, wherein processing comprises:
identify a portion of said first data set that corresponds to a previously stored data portion that is stored on at least one electronic storage medium;
replace said portion of said data set with a link to said previously stored data portion to define a modified data set; and
transfer said modified data set to said second electronic storage device.

20. The system of claim 19, wherein said filter module is further operative to:
process at least one attribute associated with said first data set and compare said at least one attribute as processed to an index of attributes stored on electronic storage medium.

21. The method of claim 20, wherein processing said at least one attribute comprises:
hashing said at least one attribute to generate at least one hash code, wherein comparing comprises comparing said at least one hash code to previously stored hash codes.

22. The method of claim 20, wherein said module is operative to process a primary data stream of said data set.

23. The method of claim 20, wherein said module is further operative to:
accessing said index stored on an electronic storage medium that is separate from said the electronic storage device that stores said previously stored data portion.

24. The method of claim 19, wherein said module is operative to:
remove said portion of data from said data set and inserting a reparse point into said data set.

25. The method of claim 24, wherein said module is further operative to:
inserting a sparse attribute into said modified data set.

26.-28. (canceled)

29. A method for providing data deduplication in a data storage application, comprising:
initiating transfer of a first data set from a first data storage device to a back-up data storage device;
intercepting said transfer of said first data set prior to receipt by said back-up data storage device;
deduplicating said first data set to remove at least a portion of previously stored data, wherein deduplicating said first data set defines a deduplicated data set; and
transferring said deduplicated data set to said back-up data storage device, wherein said deduplicated data set is stored by said back-up data storage device in place of said first data set.

30. The method of claim 29, wherein transferring from said first data storage device to said back-up storage device is performed over a communications network.

31. The method of claim 30, wherein said data deduplication is performed on said first data set prior to transfer over said communications network.

32. The method of claim 29, wherein deduplicating comprises:
identifying a data portion of said first data set that corresponds to a previously stored data portion that is stored on at least one electronic storage medium; and
replacing said portion of said data set with a link to said previously stored data portion.

33. The method of claim 32, wherein identifying said data portion that corresponds to said previously stored data portion comprises:
processing at least one attribute associated with said first data set and comparing said at least attribute as processed to an index of attributes stored on an electronic storage medium.

34.-42. (canceled)
